(19) United States
(12) Patent Application Publication
(10) Pub. No.: US 2022/0164832 A1
(43) Pub. Date: May 26, 2022

(54) SALES MANAGEMENT SERVER, SALES MANAGEMENT SYSTEM, AND SALES MANAGEMENT METHOD

(71) Applicant: NEC Corporation, Minato-ku, Tokyo (JP)

(72) Inventors: Masaaki KIMURA, Tokyo (JP); Takahiro MATSUI, Tokyo (JP); Jun UCHIMURA, Tokyo (JP)

(73) Assignee: NEC Corporation, Minato-ku, Tokyo (JP)

(21) Appl. No.: 17/436,369

(22) PCT Filed: Mar. 10, 2020
(86) PCT No.: PCT/JP2020/010157

§ 371 Date: Sep. 3, 2021

(30) Foreign Application Priority Data
Mar. 25, 2019 (JP) 2019-055990

(51) Int. Cl. G06Q 30/02; G06Q 30/06; G06Q 10/08

(52) U.S. Cl. CPC G06Q 30/0268; G06Q 10/087; G06Q 30/0641; G06Q 30/0639

(57) ABSTRACT

A sales management server that includes a generation unit and a notification unit. The generation unit generates advertisement information that includes: information about products for sale to a customer at a child store at which a product replaced by an employee of a mother store: and a number of the products for the sale. The notification unit notifies at least one of a portable communication terminal held by the customer or a device installed in the child store.

### TECHNICAL FIELD

The present disclosure relates to a sales management server, a sales management system, a sales management method, and a sales management program.

### BACKGROUND ART

In the retail industry, it is necessary to manage inventory of products in a store in order to reduce an opportunity loss. As a method of sales management, PTL 1 discloses a technique for reducing work on a store side when a customer places an order of a product in advance to a store, and the customer goes to the store and receives the ordered product. PTL 2 discloses a technique in which a user who has been registered as a member places an order to an order processing system via communication. PTL 3 discloses a technique of a remote ordering system of a lunch box in which a user brings the lunch box home.

### CITATION LIST

### Patent Literature

[PTL 1] JP 2018-005564 A
[PTL 2] JP 2001-318979 A
[PTL 3] JP H06-110907 A

### SUMMARY OF INVENTION

### Technical Problem

However, PTLs 1 to 3 described above do not disclose a technique of sales management of products in a labor-saving store or the like in which there is no employee who monitors sales, inventory management, and the like of the products.

One object of the present disclosure is to provide a sales management server, a sales management system, a sales management method, and a sales management program for solving the above problem, and for efficiently performing product sales management in a store such as a labor-saving store.

### Solution to Problem

A sales management server according to one aspect of the present disclosure includes:

a generation means for generating advertisement information including information on products for sale to a customer in a child store in which an employee of a mother store replaces a product and including a number of the products for the sale; and

a notification means for notifying at least one of a portable communication terminal held by the customer or a device installed in the child store, of the advertisement information.

A sales management system according to one aspect of the present disclosure includes:

a portable communication terminal held by a customer;

a display device installed in a child store in which an employee of a mother store replaces a product; and

a sales management server including a generation means for generating advertisement information including information on products for sale to the customer in the child store and including a number of the products for the sale, and a notification means for notifying at least one of the portable communication terminal or the display device of the advertisement information.

The generation means receives, from at least one of the portable communication terminal or the display device via the notified advertisement information, reservation information including the product to be reserved, a number of the products, and information for identifying a child store in which the customer is scheduled to receive the product.

A sales management method according to one aspect of the present disclosure includes:

generating advertisement information including information on products for sale to a customer in a child store in which an employee of a mother store replaces a product and including a number of the products for the sale; and

transmitting the advertisement information to at least one of a portable communication terminal held by the customer or a device installed in the child store.

A sales management program according to one aspect of the present disclosure causes

a computer to execute:

generating advertisement information including information on products for sale to a customer in a child store in which an employee of a mother store replaces a product and including a number of the products for the sale; and

transmitting the advertisement information to at least one of a portable communication terminal held by the customer or a device installed in the child store.

The sales management program may be stored in a non-transitory computer-readable recording medium.

### Advantageous Effects of Invention

An effect of the present disclosure is to efficiently perform sales management in a store such as a labor-saving store.

### BRIEF DESCRIPTION OF DRAWINGS

FIG. 1 is a block diagram showing a configuration of a sales management system according to a first example embodiment.

FIG. 2 is a diagram showing an example of a relationship between stores in the first example embodiment.

FIG. 3 is a view showing an example of data of inventory information stored in an inventory storage unit.

FIG. 4 is a view showing an example of an advertisement screen displayed on a portable communication terminal of a customer or a display device in a store.

FIG. 5 is a view showing an example of an order screen displayed on a portable communication terminal of a customer or a display device in a store.

FIG. 6 is a flowchart showing an example of an operation of the sales management system according to the first example embodiment.

FIG. 7 is a block diagram showing a configuration of a sales management system according to a second example embodiment.

FIG. 8 is a flowchart showing an example of an operation of the sales management system according to the second example embodiment.

FIG. 9 is a block diagram showing a configuration of a sales management server according to a third example embodiment.

FIG. 10 is a block diagram showing an example of a hardware configuration of a computer.

### EXAMPLE EMBODIMENT

In the retail industry, for the purpose of improving business efficiency and expanding to small trading areas, there has been progress of introduction of labor-saving stores or unmanned stores (hereinafter, these are collectively referred to as “labor-saving stores”) that reduce, for example, work of employees related to customer service support, in-store monitoring, inventory management, facility management, and the like, including registration and settlement of a purchased product, to reduce or eliminate the number of resident employees, by means of a computer system.

Generally, a labor-saving store is smaller in size and has a limited sales floor area than a normal store. Unlike normal stores set up in urban areas and along public roads in suburban areas, these labor-saving stores may also be set up in specific places such as, for example, office buildings, factories, station yards, hotels, and apartment buildings.

Even in such a labor-saving store, it is necessary to perform product sales management in the store in order to reduce a sales opportunity loss. That is, a technique is required in which an employee of a normal store manages inventory of the normal store in which the employee is resident, and inventory of a labor-saving store or the like in which an employee who monitors inventory of products is not present. In particular, for food and delicatessen products having a short expiration date and a short best before date, such as a lunch box and French fries, detailed management is required due to product characteristics such as a short product life and a fixed time zone in which products are sold well. Therefore, in the following example embodiments, a description is given to a sales management server and the like for allowing an employee of a normal store to efficiently perform sales management of products, particularly delicatessen products, in a store such as a labor-saving store.

Hereinafter, example embodiments will be described in detail with reference to the drawings. In the individual drawings and the individual example embodiments described in the specification, the same reference numerals are given to similar components, and the description thereof will be omitted as appropriate.

### First Example Embodiment

A first example embodiment will be described.

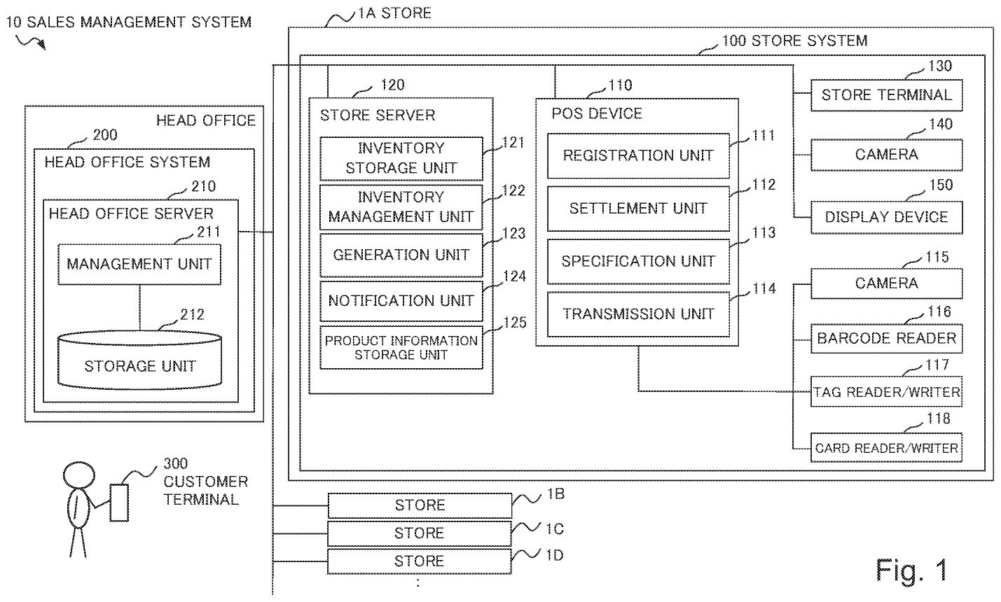

First, a configuration of a sales management system according to the first example embodiment will be described. FIG. 1 is a block diagram showing a configuration of a sales management system 10 according to the first example embodiment. Referring to FIG. 1, the sales management system 10 includes a plurality of store systems 100, a head office system 200, and a customer terminal 300. For example, the store system 100 is installed in each of stores 1A, 1B, 1C, and 1D (hereinafter, also collectively referred to as a store 1) of a chain or the like of convenience stores or supermarkets in the retail industry.

The head office system 200 is installed, for example, in a head office of the chain. The store system 100 of each store 1 and the head office system 200 are connected by, for example, a communication network. The head office system 200 includes a head office server 210, and the head office server 210 performs sales management, inventory management, and the like of products of the entire store. The head office server 210 includes a management unit 211 and a storage unit 212. The management unit 211 manages products sold in each store 1 (particularly, products having a short expiration date such as a delicatessen product). For example, the management unit 211 manages an average number of sales of products in each time zone of one day, the number of products to be delivered to each store 1 in each time zone calculated on the basis of the average number of sales, an inventory quantity of the food in each time zone, and the like. The storage unit 212 stores: an identifier (ID) for identifying each store 1; an ID for identifying a product to be sold at each store 1; an average number of sales of the food in each time zone; and a current inventory quantity, a planned number for production in the future, and the like of the food. The storage unit 212 may store, in addition to the ID for identifying each store 1, location information (global positioning system (GPS)) positioning values, map information, and the like) indicating a location of each store.

The customer terminal 300 is a portable communication terminal held by a customer of the store 1. The customer terminal 300 is communicably connectable to a network such as the Internet, and enables, on a site, viewing of detailed information of products that can be purchased at the store 1, making reservation, and order reservation, by accessing a uniform resource locator (URL) managed by the head office system 200 or installing a specific application.

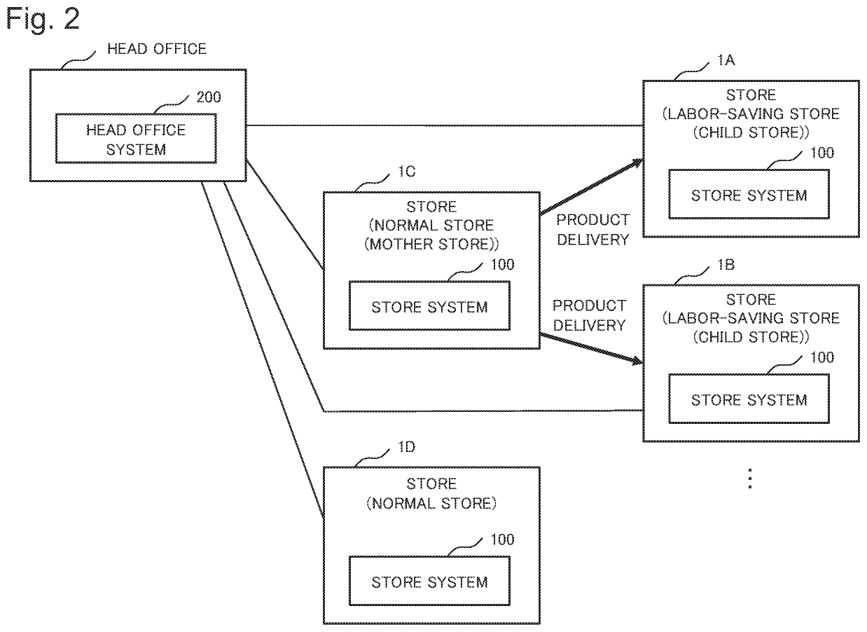

The store 1 may include a normal store and a labor-saving store. FIG. 2 is a diagram showing an example of a relationship between stores in the first example embodiment. The labor-saving store is a store, in the chain or the like, that reduces at least some of work of employees related to customer service support, in-store monitoring, inventory management, facility management, and the like, including registration and settlement of a purchased product as compared with a normal store, for example, by means of a computer system. A sales floor area of the labor-saving store may be smaller than that of the normal store.

The normal store may manage a labor-saving store that is set up in the vicinity. Here, a normal store that manages a labor-saving store is referred to as a mother store (hereinafter, also referred to as a “normal store (mother store)”), and a labor-saving store managed by the mother store is referred to as a child store (hereinafter, also referred to as a “labor-saving store (child store)”). The normal store (mother store) and the labor-saving store (child store) may be set up in different nearby buildings, or may be set up on different floors or the like in the same building.

An order and the like of a delicatessen product to be sold in the child store are placed in the store system 100 of the mother store. The store system 100 of the mother store that has received the order may produce the delicatessen product on the mother store side, or may notify the head office system 200 that the order has been received, to have the delicatessen product delivered from a production factory to the mother store.

In the child store, for example, an employee of the mother store stays when necessary for displaying delivered products, cleaning in the store, maintenance of equipment, and replenishment and collection of cash. The child store may be a store in which a minimum necessary number of employees are resident, or may be an unmanned store in which there is a time zone when no employees are present (no employees are resident).

The child store may be managed by the head office (the head office system 200) instead of the mother store. In addition, products of the child store may be directly delivered from the head office to the child store. The products to be prepared in the child store may be ordered by the store system 100 of the mother store instead of the child store.

In the example of FIG. 2, the stores 1A and 1B are the labor-saving stores (child stores), the store 1C is the normal store (mother store), and the store 1D is another normal store. However, without limiting to this, the stores 1A to 1D may be normal stores, or the stores 1A to 1D may be labor-saving stores. Each of the stores 1A to 1D is communicably connected to the head office system 200.

Referring to FIG. 1, the store system 100 includes a point of sale (POS) device 110, a store server (sales management server) 120, a store terminal 130, a camera 140, and a display device 150.

The store terminal 130 is a portable communication terminal used by an employee, and is held by each employee or installed in each store. The store terminal 130 is a portable computer, and includes at least an operation unit and a display unit (both not illustrated).

The camera 140 is a camera that is installed in a store and captures an image of an inside of the store. There may be a plurality of the cameras 140 in one store.

The display device 150 is a display monitor that is installed in a store and is for presenting a product (delicatessen product) to a customer. The display device 150 may be a digital signage, or may be a touch panel or the like of an input/output integrated type. For example, the display device 150 is designed to enable, when a customer touches a delicatessen product displayed on the signage display, browsing of detailed information on the delicatessen product, reservation of the delicatessen product (keeping of a product in stock), and order reservation (order acceptance of a product out of stock). In this case, it is desirable to request input of IDs (first IDs) for specifying customers who reserve a product and makes an order reservation. Further, a plurality of delicatessen products may be displayed on one screen. Moreover, on the basis of an image of a customer acquired from a camera (not illustrated) provided in the own device, the camera 140, or the like, the display device 150 may estimate an attribute (gender, age, and the like) of a customer, and determine contents of a product to be displayed on the signage display (to be recommended to the customer) on the basis of the estimation result.

The POS device 110 performs accounting processing (product registration and settlement) when a customer who has come to the store 1 purchases a product. Further, the POS device 110 may specify an ID for identifying a customer who purchases a product. The POS device 110 may be communicably connected to the display device 150.

For example, product registration and settlement may be performed by an operation of an employee of the store 1, or may be performed by an operation of a customer. In addition, a product may be registered by an operation of an employee of the store 1, and settlement may be performed by an operation of a customer.

The POS device 110 includes a registration unit 111, a settlement unit 112, a specification unit 113, and a transmission unit 114. The POS device 110 may be connected with a camera 115, a barcode reader 116, a tag reader/writer 117, and a card reader/writer 118.

The registration unit 111 registers a product to be purchased by a customer. Here, the registration unit 111 specifies and registers a product by reading, for example, a two-dimensional code such as a QR code (registered trademark) or a barcode given to a product and indicating a product ID, by the camera 115 or the barcode reader 116 connected to the POS device 110. Similarly, the registration unit 111 may specify and register a product by reading an IC tag, in which the product ID is written, attached to the product, by the tag reader/writer 117. Furthermore, the registration unit 111 may specify and register a product by image recognition using a product image captured by the camera 115. In addition, from an image of the inside of the store captured by another camera 140 installed in the store 1, the registration unit 111 may specify and register a product removed from a product shelf or the like by the customer, by image recognition. The registration unit 111 outputs information on the registered product to the settlement unit 112.

The settlement unit 112 settles a product to be purchased by a customer. Here, the settlement unit 112 uses cash, electronic money, a credit card, a two-dimensional code payment, a barcode payment, or the like to settle a payment for a registered product. For example, the settlement unit 112 causes the card reader/writer 118 connected to the POS device 110 to acquire information of a credit card or electronic money in a magnetic form or a contactless IC card form presented by a customer, to settle a payment. Further, the settlement unit 112 may settle a payment by using the camera 115 or the barcode reader 116 to acquire information of a two-dimensional code or a barcode displayed on a payment application operating on a terminal of a customer. Moreover, the settlement unit 112 may specify a customer by face image authentication using a customer's face image acquired by the camera 115 or the camera 140, and settle a payment using electronic money, a credit card, a bank account, or the like registered in advance in association with the customer. In this case, the settlement unit 112 may specify a member, for example, by collating a feature amount of the face image with a feature amount of a face image registered in advance in association with a member ID of the chain. In addition, the settlement unit 112 may specify a member by another biometric authentication means such as iris authentication, fingerprint authentication, or vein authentication.

The specification unit 113 specifies a customer ID for identifying a customer who purchases a product. For example, the specification unit 113 acquires, by the card reader/writer 118, the member ID from a membership card in a magnetic form or a contactless IC card form presented by a customer. In addition, the specification unit 113 may acquire, by the camera 115 or the barcode reader 116, the member ID from a barcode or a two-dimensional code displayed in a member application operating on a terminal of a customer. In addition, the specification unit 113 may specify the member ID by a biometric authentication means such as face image authentication using the face image of the customer described above. The specified member ID may be used for accumulation of shopping points associated with the member ID. In general, when the registration unit 111 registers a product (before or after registration or during registration), the specification unit 113 acquires the member ID. When acquiring the member ID, the specification unit 113 determines whether there is a reserved product associated with the member ID. The specification unit 113 accesses an inventory storage unit 121 of the store server 120 via an inventory management unit 122, and determines whether there is a reserved product associated with the customer ID. When determining that there is a reserved product, the specification unit 113 determines whether the reserved product is a product registered in the registration unit 111. The specification unit 113 may specify a customer ID (second ID) of a customer who intends to purchase the reserved product, to determine whether the first ID and the second ID described above match each other, and may control the settlement unit 112 to enable settlement of the product only when the first ID and the second ID match. The customer ID specified by the specification unit 113 is transferred to the transmission unit 114.

The transmission unit 114 generates purchase information each time a product is settled by the settlement unit 112, and transmits the purchase information to the store server 120. The purchase information is customer purchase information for description on a receipt generated by the general POS device 110. The purchase information includes, for example, a store ID enabling a store to be specified, a settlement date and time, a purchased product, the number of purchased products, a product price, and a total purchase amount.

The store server 120 includes the inventory storage unit 121, the inventory management unit 122, a generation unit 123, a notification unit 124, and a product information storage unit 125.

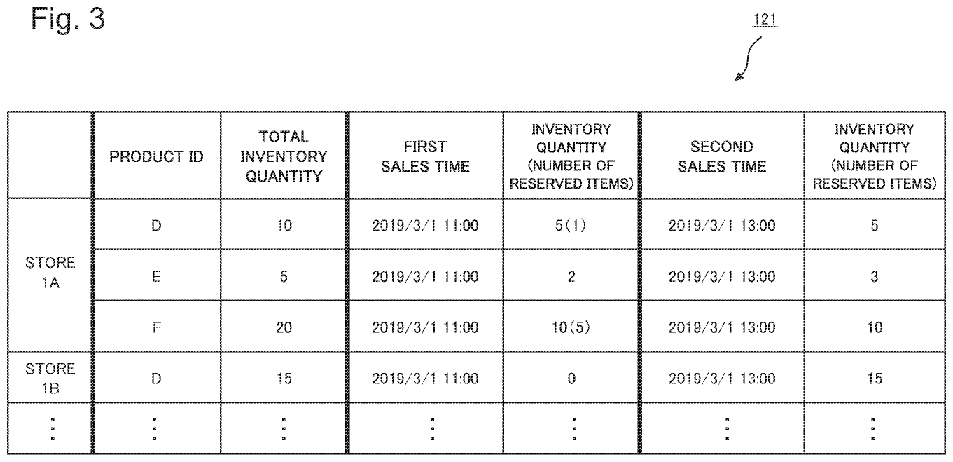

The inventory storage unit 121 stores inventory information. As the inventory information, at least information for identifying the own store (including a parent store and a child store), information on a product for sale at the own store, the number of products for the sale, and a time for the sale (including a scheduled sales time) are stored. Specifically, the inventory information includes a store ID, an ID for identifying a plurality of products sold at each store, a sales time of each of the products, and an inventory quantity of each of the products. For example, as shown in FIG. 3, the inventory information includes a product ID, a total inventory quantity, a first sales time and an inventory quantity thereof, a second sales time and an inventory quantity thereof. The second sales time is a time after the first sales time. The inventory quantity may include the number of reserved items. The number of reserved items is the number of items whose purchase schedules have been notified by customers, among the products in stock. For example, an inventory quantity of a product with the product ID “D” of the store 1A is 5 at the first sales time, but one item is reserved (purchase reservation) via the display device 150 or the customer terminal 300. Further, an inventory quantity of a product with a product ID “F” is 10 at the first sales time, but five items are reserved via the display device 150 or the customer terminal 300.

The inventory storage unit 121 may further store location information (for example, map information) of the own store and another store, and an inventory quantity of each product in the stores. The customer ID (first ID) may be acquired by the specification unit 113 or the like at the time of acceptance of reservation from a customer, and the customer ID may be associated with “number of reserved items” shown in FIG. 3. In addition, the customer ID may be displayed by selecting the “number of reserved items” by tapping, clicking, or the like.

The first sales time and the second sales time are respectively the same sales time. In addition, a sales period may include the future. For example, suppose that the current time is 12 o'clock at 2019/3/1. In this case, an inventory quantity at the second sales time (13 o'clock on the same day) indicates a scheduled inventory quantity in the future. In FIG. 3, a sales start time is described as the sales time, but a sales end time such as a best before time may be described. The product is desirably collected by an employee or the like before the sales end time.

The product information storage unit 125 stores images, descriptions, and the like of individual products handled in the store.

When a product is purchased at the POS device 110, the inventory management unit 122 updates inventory information of the product. Specifically, when the store server 120 receives purchase information from the transmission unit 114 of the POS device 110, the inventory management unit 122 updates the inventory information on the basis of the purchase information. The purchase information includes a store ID, a settlement date and time, a purchased product, the number of purchased products, a product price, and the like. In a case of a reserved product, a customer ID may be included in order to determine whether being identical to the customer who has made the purchase reservation.

The generation unit 123 generates advertisement information including information on a product for sale to a customer in a child store in which an employee of a mother store replaces a product and a number of products for the sale. The advertisement information may further include information (a store ID) for identifying a child store in which a product is sold and a sales start time of the product, which are acquired from the inventory storage unit 121. The generation of the advertisement information may be performed in accordance with an inventory status (presence or absence of stock, presence of stock equal to or more than a predetermined value, and the like) of a product, stock preparation (for example, an amount of ingredients of a lunch box or a degree of preparation for cooking).

The generation unit 123 may further acquire, from the inventory storage unit 121, information (map information or the like) for identifying a location of a child store in which a product is sold, and an inventory quantity of each product (particularly a delicatessen product) to be sold in the child store, to include in the advertisement information.

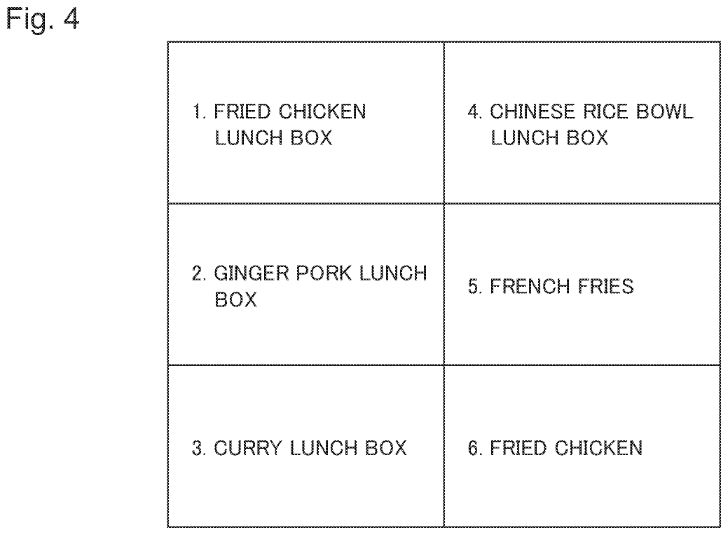

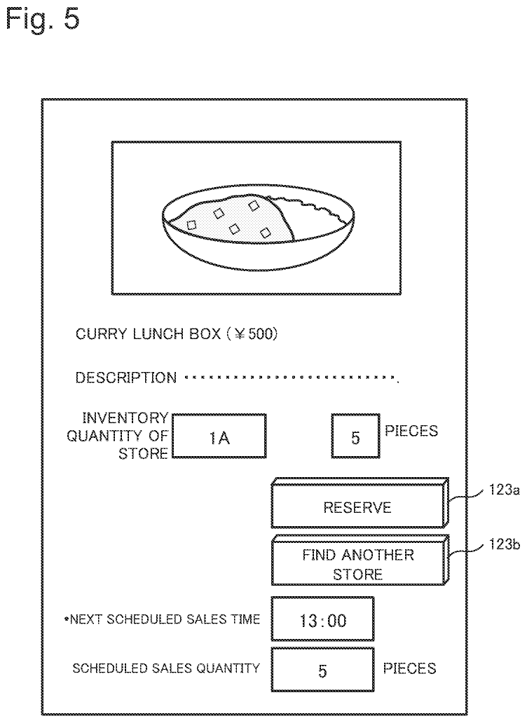

The advertisement information is information that is of a product such as a delicatessen product and is to be presented to a customer. The advertisement information may include detailed information of a product, a current inventory quantity, a sales start time, a URL link for connecting to reservation or order reservation of the product, and the like. The advertisement information may be generated so as to be simultaneously displayed for a plurality of products. For example, as shown in FIG. 4, an advertisement screen for six types of delicatessen products may be presented. The advertisement screen is presented on the display device 150 in the store and/or the customer terminal 300. Suppose that, in FIG. 4, a customer selects “3. Curry lunch box” by tap processing or the like. In this case, the generation unit 123 acquires a current inventory quantity, a next scheduled sales time, a next scheduled sales quantity, and the like from the inventory storage unit 121. Further, the generation unit 123 acquires an image, a description, and the like of the product from the product information storage unit 125, generates an order image as shown in FIG. 5, and presents to the display device 150 in the store and/or the customer terminal 300. When the customer selects a “reserve” button 123a on the order screen of FIG. 5 by pressing, tapping, or the like, the generation unit 123 presents a reservation screen (not illustrated) to prompt input for the number of items to be reserved, a customer ID of the customer, and the like. When the number of reserved items, the customer ID, and the like are acquired, the generation unit 123 transfers the product ID, the number of reserved items, and the customer ID, as reservation information, to the inventory management unit 122 and the settlement unit 112 of the POS device 110. At the time of reservation, an advance payment may be settled. In this case, the generation unit 123 notifies the settlement unit 112 of the fact of the advance payment, and transmits the advance payment information. The advance payment information includes a product ID for which the advance payment is settled, the number of the advance payments, and a store ID of a child store at which a customer receives the product.

The settlement unit 112 uses electronic money, a credit card, a two-dimensional code payment, a barcode payment, or the like to settle a payment for the product to be reserved. The settlement unit 112 may settle a payment by using the camera 115 or the barcode reader 116 to acquire information of a two-dimensional code or a barcode displayed on a payment application operating on a terminal of a customer.

The notification unit 124 notifies (transmits) at least one of the customer terminal 300 or the display device 150 of the store system 100, of the advertisement information or the like generated by the generation unit 123, to cause an advertisement to be displayed on at least one of the customer terminal 300 or the display device 150 of the store system 100. Here, the notification unit 124 may determine which one of the customer terminal 300 and the display device 150 of the store system 100 is to be notified of the generated advertisement information or the like. For example, in a case where the specification unit 113 specifies a customer ID via the display device 150, the notification unit 124 determines to notify the display device 150. The notification unit 124 can also transmit the advertisement information or the like generated by the generation unit 123, to both the customer terminal 300 and the display device 150 of the store system 100.

(Operation of Sales Management System)

An operation of the first example embodiment will be described.

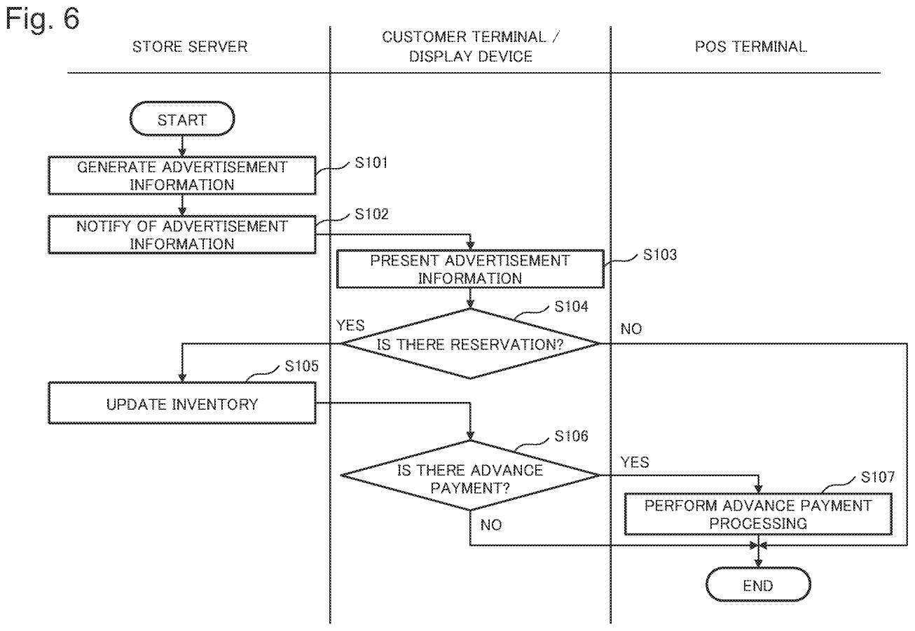

FIG. 6 is a flowchart showing sales management processing in the first example embodiment.

The generation unit 123 of the store server 120 in the store system 100 in each store 1 generates advertisement information for advertising a product such as a delicatessen product to a customer (step S101). The notification unit 124 notifies at least one of the display device 150 or the customer terminal 300 of the store system 100, of the generated advertisement information (step S102). The display device 150 and the customer terminal 300 receive the advertisement information notified from the notification unit 124, and present the received advertisement information as an order screen (step S103). When an input indicating reservation of a product is received from a customer on the order screen (YES in step S104), the display device 150 and the customer terminal 300 transmit the inputted reservation information to the store server 120, and the inventory management unit 122 of the store server 120 updates inventory data of the product to be reserved in the inventory storage unit 121, on the basis of the received reservation information (step S105). Further, when an input indicating an advance payment for a product is received from a customer on the order screen (YES in step S106), the display device 150 and the customer terminal 300 transmit a notification of the advance payment to the POS terminal, and the settlement unit 112 of the POS device 110 performs advance payment (settlement) for the product to be purchased by the customer (step S107). If no input indicating reservation of the product is received from a customer (NO in step S104), the process ends.

When a customer actually comes to a store to receive a product, and the product is read by the barcode reader 116 or the like connected to the POS device 110, the settlement unit 112 notifies the inventory management unit 122 of the store server 120, of the read product, that is, the product whose stock has decreased. The inventory management unit 122 updates inventory information (an inventory quantity) of the inventory storage unit 121. Specifically, as shown in FIG. 3, in a case where the inventory quantity is 5 at the first sales time and the number of reserved items is 1, when the customer purchases one reserved product, a value obtained by subtracting the number of reserved items from the inventory quantity, that is, 4 is registered in the inventory information as a new inventory quantity. In this case, the generation unit 123 can be configured to generate advertisement information again on the basis of a new inventory status when the new inventory quantity becomes equal to or less than a predetermined value. In a case where no input indicating an advance payment is received from a customer (NO in step S106), the process ends.

In this way, the operation of the first example embodiment is completed.

(Modification)

In step S103, when an inventory quantity of a product desired by a customer is 0, the generation unit 123 may generate information or an instruction for displaying a “find another store” button (see FIG. 5) on the order screen. When the button is pressed or tapped on the screen, the display device 150 and the customer terminal 300 may transmit a notification for searching for another store to the inventory management unit 122, and the inventory management unit 122 may inquire of the head office server 210 whether there is a store having stock of the product in the vicinity. Specifically, when a customer presses or taps to select a “find another store” button 123b on the order screen of FIG. 5, the inventory management unit 122 accesses the head office server 210 via a communication network connecting the store system 100 and the head office system 200, and inquires whether there is another store in the vicinity having stock of the product. The management unit 211 of the head office server 210 searches the storage unit 212 to determine whether there is a store having stock of the product among other stores in the vicinity. Then, when there is a relevant store as a result of the search, the management unit 211 acquires map information of the store, an inventory quantity of the product, and the like from the storage unit 212, to transfer to the store server 120. When the generation unit 123 of the store server 120 receives the map information of the store, the inventory quantity of the product, and the like, the generation unit 123 generates an order screen including the map information of the store and the inventory quantity of the product, and presents to the display device 150 in the store and/or the customer terminal 300. On the basis of the presented information, the customer determines whether to go to the store having stock. For example, referring to FIG. 3, it is assumed that a customer goes to the store 1B to purchase a product with a product ID “D” at 11 o'clock on 2019/3/1, but there is no stock. In this case, when the product ID “D” is “3. curry lunch box”, the order screen shown in FIG. 5 is presented. However, since “0” is presented as the inventory quantity, the customer presses or taps the “find another store” button 123b on the screen. In this case, in response to a request from the inventory management unit 122 of the store server 120 of the store 1B, the head office server 210 transmits map information of the store 1A having stock of the product ID “D” and the inventory quantity “5(1)” of the product, to the store server 120. The generation unit 123 of the store server 120 that has received this information presents an order screen generated on the basis of the map information of the store 1A and the inventory quantity “5 (1)” of the product, to the display device 150 in the store and/or the customer terminal 300.

(Effect of First Example Embodiment)

According to the first example embodiment, it is possible to efficiently perform sales management in a specific store such as a labor-saving store. The reason is that the generation unit 123 generates advertisement information in accordance with preparation of inventory of a product, and the notification unit 124 notifies at least one of the customer terminal 300 or the display device 150 of the store system 100 of the advertisement information or the like.

### Second Example Embodiment

There may be a case where no stock of a product (particularly a delicatessen food) desired by a customer is in any store. In such a case, the store system 100 may receive an order of a product from a customer via a display device 150 in a store or a customer terminal 300. In a second example embodiment, a sales management system that receives an order of a product from a customer will be described.

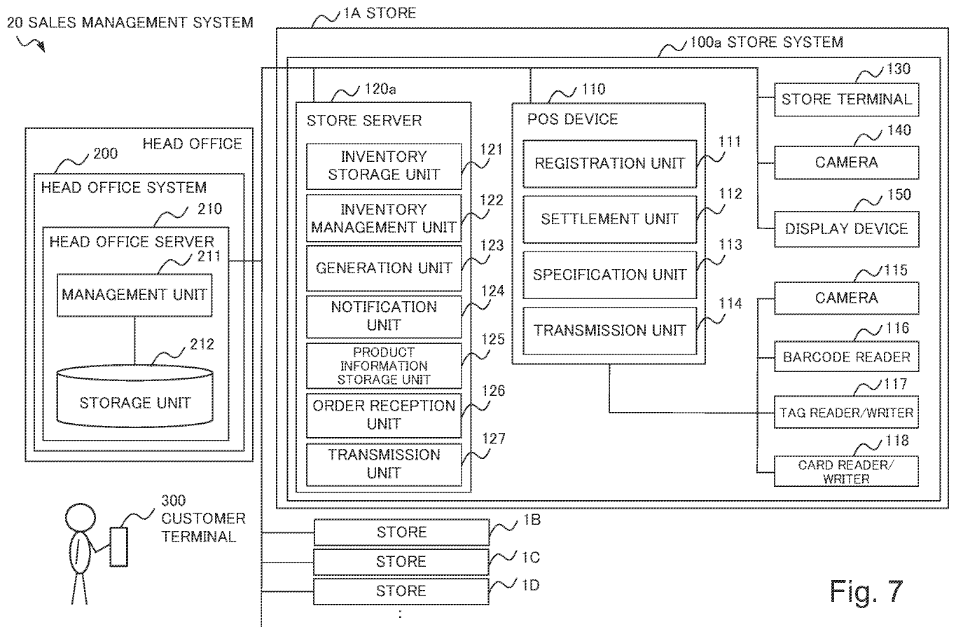

As shown in FIG. 7, a sales management system 20 according to the second example embodiment includes a plurality of store systems 100a, a head office system 200, and a customer terminal 300. The store system 100a includes a POS device 110, a store server (sales management server) 120a, a store terminal 130, a camera 140, and a display device 150. The store server 120a includes an inventory storage unit 121, an inventory management unit 122, a generation unit 123, a notification unit 124, a product information storage unit 125, an order reception unit 126, and a transmission unit 127.

The order reception unit 126 receives order information from the display device 150 of the store system 100a or from the customer terminal 300. The order information includes the number of orders for a product, and information (a store ID) for identifying a child store in which a customer purchases the product. The order reception unit 126 performs pre-order processing. Specifically, when receiving the order information, the order reception unit 126 presents contents of the order information to an employee via the store terminal 130, a display (not illustrated), or the like, to prompt the employee to determine whether to accept the order. When the order is accepted, input of a scheduled delivery time is prompted. The order reception unit 126 acquires propriety of the order, the scheduled delivery time, and the like inputted from the employee, and transfers to the transmission unit 127.

In response to the order information, the transmission unit 127 transmits whether the product can be delivered to the child store, and the scheduled delivery time in a case where the product is to be delivered.

Configurations of other parts are similar to those of the first example embodiment.

(Operation of Sales Management System)

An operation of the second example embodiment will be described.

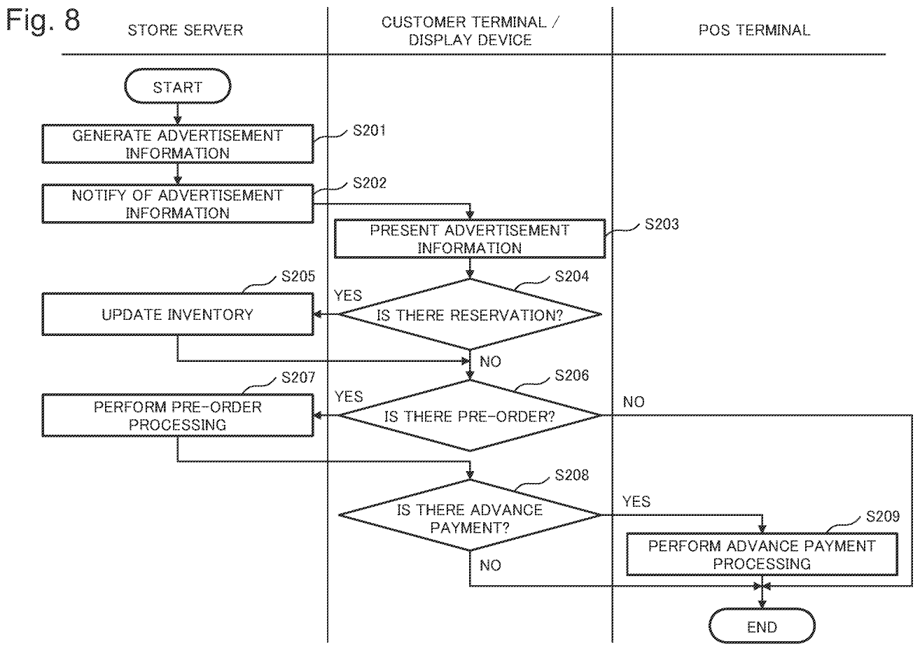

FIG. 8 is a flowchart showing sales management processing in the second example embodiment.

The generation unit 123 of the store server 120a in the store system 100a in each store 1 generates advertisement information for advertising a product such as a delicatessen product to a customer (step S201). The notification unit 124 notifies at least one of the display device 150 or the customer terminal 300 of the store system 100a, of the generated advertisement information (step S202). The display device 150 and the customer terminal 300 present the received advertisement information as an order screen (step S203). When an input indicating reservation of a product in stock is received from a customer on the order screen (YES in step S204), the display device 150 and the customer terminal 300 transmit the inputted reservation information to the store server 120. Then, on the basis of the received reservation information, the inventory management unit 122 of the store server 120 updates inventory data of the product to be reserved in the inventory storage unit 121 (step S205). If no input indicating reservation of the product is received from a customer (NO in step S204), the process proceeds to step S206.

In a case where an input indicating pre-ordering of a product is received from a customer on the order screen, due to a reason that there is no stock of the product or the like (YES in step S206), the display device 150 and the customer terminal 300 transmit information of the pre-ordering to the store server 120a. Then, the order reception unit 126 of the store server 120a performs pre-order processing (step S207), and the process proceeds to step S208 after the pre-order processing. If no input indicating reservation of the product is received from a customer (NO in step S206), the process ends.

In step S208, when an input indicating an advance payment for a product is received from a customer on the order screen (YES in step S208), the display device 150 and the customer terminal 300 transmit information of the advance payment to the POS device 110, and a settlement unit 112 of the POS device 110 performs the advance payment (settlement) for the product to be purchased by the customer (step S209). In a case where no input indicating an advance payment is received from a customer (NO in step S208), the process ends.

Steps S201 to S203 and S205 are similar to the operations of steps S101 to S103 and S105 in FIG. 6, and steps S208 and S209 are similar to the operations of steps S106 and S107 in FIG. 6.

In this way, the operation of the second example embodiment is completed.

### Third Example Embodiment

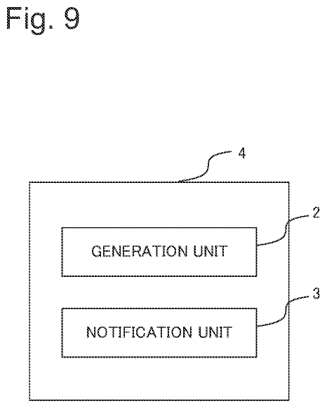

FIG. 9 is a block diagram showing a configuration of a sales management server 4 according to a third example embodiment. The sales management server 4 includes a generation unit 2 and a notification unit 3. The generation unit 2 and the notification unit 3 are example embodiments of a generation means and a notification means, respectively.

The generation unit 2 generates advertisement information including information on a product for sale to a customer in a child store in which an employee of a mother store replaces a product and a number of products for the sale. The notification unit 3 notifies at least one of a portable communication terminal held by a customer or a display device installed in a child store, of the generated advertisement information.

An effect of the third example embodiment will be described. According to the third example embodiment, it is possible to efficiently perform sales management in a specific store such as a labor-saving store. The reason is that the generation unit 2 generates advertisement information in accordance with preparation of inventory of a product, and the notification unit 3 notifies at least one of the customer terminal or the display unit of the store system of advertisement information or the like.

(Hardware Configuration)

In each of the above-described example embodiments, each component of each of devices (the head office server 210, the POS device 110, the store servers 120 and 120a, and the like) indicates a block of a functional unit. Some or all of each component of each devices may be implemented by any combination of a computer 500 and a program.

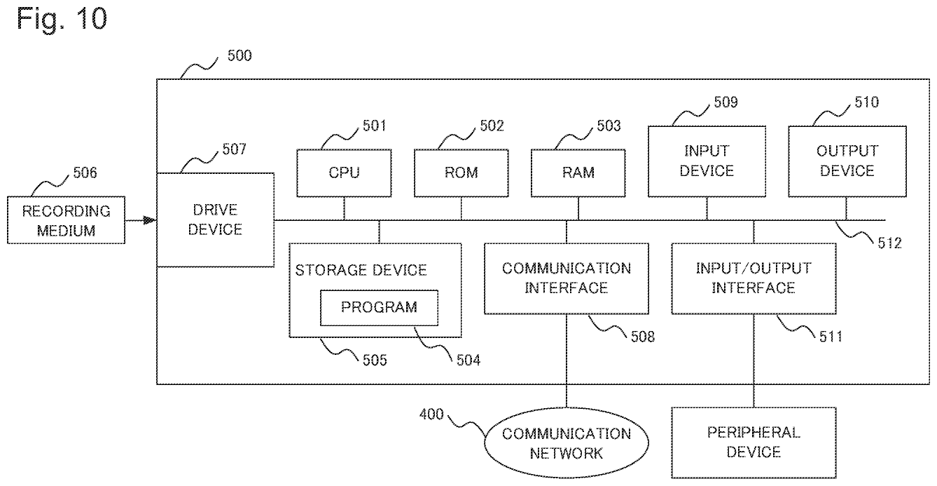

FIG. 10 is a block diagram showing an example of a hardware configuration of the computer 500. Referring to FIG. 10, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for implementing each function of each device. The program 504 is stored in advance in the ROM 502, the RAM 503, and the storage device 505. The CPU 501 implements each function of each device by executing instructions included in the program 504. For example, the CPU 501 of the store server 120 executes an instruction included in the program 504 to implement functions of the inventory management unit 122, the generation unit 123, and the notification unit 124. Furthermore, the RAM 503 may store data to be processed in each function of each device. For example, the RAM 503 of the store server 120 may store data of the inventory storage unit 121 and the product information storage unit 125.

The drive device 507 reads from and writes into a recording medium 506. The communication interface 508 provides an interface between with a communication network. The input device 509 is, for example, a mouse, a keyboard, or the like, and receives an input of information from an employee, an administrator of the head office system 200, or the like. The output device 510 is, for example, a display, and outputs (displays) information to an administrator or the like. The input/output interface 511 provides an interface between with a peripheral device. In a case of the POS device 110, the input/output interface 511 is connected with the camera 115, the barcode reader 116, the tag reader/writer 117, and the card reader/writer 118 described above. The bus 512 connects individual components of hardware. The program 504 may be supplied via the communication network to the CPU 501, or may be stored in advance in the recording medium 506 and supplied to the CPU 501 by being read by the drive device 507.

The hardware configuration shown in FIG. 10 is an example, and other components may be added or some components may not be included.

There are various modifications for a method of implementing each device. For example, each device may be implemented by any combination of a computer and a program that are different for each component. Further, a plurality of components included in each device may be implemented by any combination of one computer and a program.

In addition, part or all of components of each device may be implemented by general-purpose or dedicated circuitry including a processor or the like, or a combination thereof. These pieces of circuitry may be configured by a single chip or a plurality of chips connected via a bus. Some or all of the individual components of each device may be implemented by a combination of the above-described circuitry and the like and a program.

Further, in a case where some or all of each component of each device is implemented by a plurality of computers, pieces of circuitry, and the like, the plurality of computers, pieces of circuitry, and the like may be arranged in a centralized manner or in a distributed manner.

Further, the store server 120 may be disposed in the store 1, or may be disposed in a place different from the store 1 and connected to the POS 110 and the store terminal 130 via a communication network. That is, the store server 120 may be implemented by a cloud computing system. Similarly, the head office server 210 may also be implemented by a cloud computing system.

While the present disclosure has been particularly shown and described with reference to the example embodiments thereof, the present disclosure is not limited to these example embodiments. It will be understood by those of ordinary skill in the art that various changes in form and details may be made therein without departing from the spirit and scope of the present disclosure as defined by the claims. In addition, the configurations in the individual example embodiments can be combined with each other without departing from the scope of the present disclosure.

Some or all of the above example embodiments may be described as follows, but are not limited to the following Supplementary Notes.
[Supplementary Note 1]

A sales management server including:

a generation means for generating advertisement information including information on products for sale to a customer in a child store in which an employee of a mother store replaces a product and including a number of the products for the sale; and

a notification means for notifying at least one of a portable communication terminal held by the customer or a device installed in the child store, of the advertisement information.
[Supplementary Note 2]

The sales management server according to Supplementary Note 1, further including:

an inventory storage means for storing at least information for identifying each of at least one or more of the child stores, information on the products for sale at the child store, a number of the products for the sale, and a time of the sale, in which

the generation means generates the advertisement information further including information for identifying the child store in which the product is sold and a time at which the product starts to be sold.
[Supplementary Note 3]

The sales management server according to Supplementary Note 2, in which

the inventory storage means further stores information for identifying a location of the child store, and an inventory quantity of the product in the child store, and

the generation means generates the advertisement information further including information for identifying a location of the child store in which the product is sold and an inventory quantity of the products in the child store.
[Supplementary Note 4]

The sales management server according to any one of Supplementary Notes 1 to 3, in which

from at least one of the portable communication terminal or a device installed in the child store, the generation means receives reservation information including a product to be reserved, a number of the products, and information for identifying a child store in which the customer is scheduled to receive the product.
[Supplementary Note 5]

The sales management server according to any one of Supplementary Notes 1 to 4, in which

from at least one of the portable communication terminal or a device installed in the child store, the generation means receives advance payment information including an advance payment of the product, a number of the advance payments, and information for identifying a child store in which the customer receives the product.
[Supplementary Note 6]

The sales management server according to any one of Supplementary Notes 1 to 5, further including:

an order reception means for receiving, from at least one of the portable communication terminal or a device installed in the child store, order information including an order for the product, a number of the orders, and information for identifying a child store in which the customer purchases the product; and

a transmission means for transmitting, in response to the order information, a time at which the product is delivered to the child store.
[Supplementary Note 7]

A sales management system including:

a portable communication terminal held by a customer;

a display device installed in a child store in which an employee of a mother store replaces a product; and

a sales management server including a generation means for generating advertisement information including information on products for sale to the customer in the child store and including a number of the products for the sale, and a notification means for notifying at least one of the portable communication terminal or the display device of the advertisement information, in which

the generation means receives, from at least one of the portable communication terminal or the display device via the notified advertisement information, reservation information including the product to be reserved, a number of the products, and information for identifying a child store in which the customer is scheduled to receive the product.
[Supplementary Note 8]

The sales management system according to Supplementary Note 7, in which

the sales management server further includes:

an order reception means for receiving, from at least one of the portable communication terminal or a device installed in the child store, order information including an order for the product, a number of the orders, and information for identifying a child store in which the customer purchases the product.
[Supplementary Note 9]

A sales management method including:

generating advertisement information including information on products for sale to a customer in a child store in which an employee of a mother store replaces a product and including a number of the products for the sale; and

transmitting the advertisement information to at least one of a portable communication terminal held by the customer or a device installed in the child store.
[Supplementary Note 10]

A storage medium storing a program for causing

a computer to execute:

generating advertisement information including information on product for sale to a customer in a child store in which an employee of a mother store replaces a product and including a number of the products for the sale; and

transmitting the advertisement information to at least one of a portable communication terminal held by the customer or a device installed in the child store.

This application is based upon and claims the benefit of priority from Japanese patent application No. 2019-055990, filed on Mar. 25, 2019, the disclosure of which is incorporated herein in its entirety by reference.

### REFERENCE SIGNS LIST

1 store
1A child store
1B child store
1C mother store
1D mother store
2 generation unit
3 notification unit
4 sales management server
10 sales management system
20 sales management system
100 store system
100a store system
110 POS device
111 registration unit
112 settlement unit
113 specification unit
114 transmission unit
115 camera
116 barcode reader
117 tag reader/writer
118 card reader/writer
120 store server (sales management server)
120a store server (sales management server)
121 inventory storage unit
122 inventory management unit
123 generation unit
124 notification unit
125 product information storage unit
126 order reception unit
127 transmission unit
130 store terminal
140 camera
150 display device
200 head office system
210 head office server
211 management unit
212 storage unit
300 customer terminal
500 computer
501 CPU
502 ROM
503 RAM
504 program
505 storage device
506 recording medium
507 drive device
508 communication interface
509 input device
510 output device
511 input/output interface
512 bus

What is claimed is:

1. A sales management server comprising:
a memory storing instructions; and
one or more processors configured to execute the instructions to:
generate advertisement information including information on products for sale to a customer in a child store in which an employee of a mother store replaces a product, the advertisement information including a number of the products for the sale; and
notify at least one of a portable communication terminal held by the customer or a device installed in the child store, of the advertisement information.

2. The sales management server according to claim 1, wherein,
the one or more processors are further configured to execute the instructions to:
store at least information for identifying each of at least one or more of the child stores, information on the products for sale at the child store, a number of the products for the sale, and a time of the sale; and
generate the advertisement information further including information for identifying the child store in which the product is sold and a time at which the product starts to be sold.

3. The sales management server according to claim 2, wherein
the one or more processors are further configured to execute the instructions to
store information for identifying a location of the child store, and an inventory quantity of the products in the child store, and
generate the advertisement information further including information for identifying a location of the child store in which the product is sold and an inventory quantity of the products in the child store.

4. The sales management server according to claim 1, wherein
the one or more processors are further configured to execute the instructions to
receive, from at least one of the portable communication terminal or a device installed in the child store, reservation information including a reserved product, a number of the reserved products, and information for identifying a child store in which the customer is scheduled to receive the product.

5. The sales management server according to claim 1, wherein
the one or more processors are further configured to execute the instructions to
receive, from at least one of the portable communication terminal or a device installed in the child store, advance payment information including an advance payment of the product, a number of the advance payments, and information for identifying a child store in which the customer receives the product.

6. The sales management server according to claim 1, wherein
the one or more processors are further configured to execute the instructions to
receive, from at least one of the portable communication terminal or a device installed in the child store, order information including an order for the product, a number of the orders, and information for identifying a child store in which the customer purchases the product; and
transmit, in response to the order information, a time at which the product is delivered to the child store.

7. A sales management system comprising:
a portable communication terminal held by a customer;
a display device installed in a child store in which an employee of a mother store replaces a product; and
a sales management server comprising: a memory storing instructions; and one or more processors configured to execute the instructions to:
generate advertisement information including information on products for sale to the customer in the child store, the advertisement information including a number of the products for the sale, and a notification means for notifying at least one of the portable communication terminal or the display device of the advertisement information; and
receive, from at least one of the portable communication terminal or the display device via the notified advertisement information, reservation information including a reserved product, a number of the reserved products, and information for identifying a child store in which the customer is scheduled to receive the product.

8. The sales management system according to claim 7, wherein
the one or more processors are further configured to execute the instructions to
receive, from at least one of the portable communication terminal or a device installed in the child store, order information including an order for the product, a number of the orders, and information for identifying a child store in which the customer purchases the product.

9. A sales management method comprising:
generating advertisement information including information on products for sale to a customer in a child store in which an employee of a mother store replaces a product, the advertisement information including a number of the products for the sale; and
transmitting the advertisement information to at least one of a portable communication terminal held by the customer or a device installed in the child store.

10. (canceled)
